(19) United States
(12) Patent Application Publication
(10) Pub. No.: US 2008/0189174 A1
(43) Pub. Date: Aug. 7, 2008

(54) ADVERTISEMENT REFERRAL BASED ON SOCIAL TIES

(75) Inventor: Paul Cameron Moore, Redwood City, CA (US)

Correspondence Address: BEYER LAW GROUP LLP/YAHOO, PO BOX 1687, CUPERTINO, CA, 95015-1687, US

(73) Assignee: YAHOO! INC., Sunnyvale, CA (US)

(21) Appl. No.: 11/670,013

(22) Filed: Feb. 1, 2007

(51) Int. Cl. G06Q 30/00

(52) U.S. Cl. 705/14

(57) ABSTRACT

It is determined that a particular user of network-based services has been presented or additionally has monetized a monetization opportunity (such as an advertisement) offered to the particular user via a computer network. Monetizing the monetization opportunity may include, for an advertisement, clicking on the advertisement such that money is made (typically at least in part by the service provider) as a result. Based on the determination, a monetization opportunity is caused to be referred, via the computer network, to at least one other user of the network-based services, other than the particular user, with whom the particular user has social ties. For example, the particular user may have a social tie with the at least one other user via network-based services, such as instant messaging. The social tie may be other than via network-based services, as well.

### BACKGROUND

It is generally desired to target advertising to people who have a high probability of responding to the advertising. For example, advertising may be targeted to users of a search engine, where particular advertisements provided to a user are based at least in part on the search term entered by that user. When an advertisement is targeted to a user of a service provided over the internet or other computer network, and the user clicks on the advertisement, the advertisement may be “monetized,” such that the advertiser pays the service provider for the “click.”

If the probability of a user clicking on an advertisement can be increased then, in general, more revenue can be generated from the advertisement for the service provider due to the higher number of clicks (“clickthrough rate”). In addition, if the clickthrough rate is increased, the service provider may be able to charge more for each display or click of the advertisement.

### SUMMARY

A computer-implemented monetization opportunity referral method includes determining that a particular user of network-based services has been presented or additionally has monetized a monetization opportunity offered to the particular user via a computer network. For example, the monetization opportunity may be an advertisement provided to the particular user as part of a network-based service, such as displaying one or more advertisements in conjunction with displaying search results from a search engine. Monetizing the monetization opportunity may include, for an advertisement, clicking on the advertisement such that money is made (typically at least in part by the service provider) as a result.

Based on the determination, a monetization opportunity is caused to be referred, via the computer network, to at least one other user of the network-based services, other than the particular user, with whom the particular user has social ties. For example, the particular user may have a social tie with the at least one other user via network-based services, such as instant messaging. The social tie may be other than via network-based services as well.

### BRIEF DESCRIPTION OF THE DRAWINGS

FIG. 1 is a block diagram illustrating an example architecture of a system in which a monetization opportunity that is determined to have been presented or additionally monetized is referred, via the computer network, to at least one other user of the network-based services with whom the particular user has social ties.

FIG. 2 is a flowchart illustrating an example of processing (e.g., within the referral engine 120 of the FIG. 1 system) to achieve a referral of a monetization opportunity.

FIG. 3 is a flowchart illustrating an example of processing with respect to a user interface via which a user may indicate the other users to whom a monetization opportunity is to be referred.

FIG. 4 is a block diagram illustrating the architecture of a system in which a targeting engine configuration may be adjusted to adjust the other users to whom a referred monetization opportunity is targeted.

FIG. 5 is a flowchart illustrating processing that may occur with respect to the FIG. 4 system.

### DETAILED DESCRIPTION

The inventor has realized that, by using social tie information to refer advertisements to other users, clickthrough rate may be enhanced. In accordance with a broad aspect, it is determined that a particular user of network-based services has monetized a monetization opportunity offered to the particular user via a computer network. For example, the monetization opportunity can be an opportunity to make money, such as an advertisement. By clicking on the advertisement, the user can monetize the advertisement. That is, the provider of the advertisement or an affiliated party, such as a search engine provider, may collect money each time a user clicks on an advertisement. Based at least in part on the determination that the monetization opportunity is monetized, a monetization opportunity (e.g., an advertisement on which the particular user clicked or another advertisement) is referred, via the computer network, to at least one other user of the network-based services, other than the particular user, with whom the particular user has social ties.

The social ties may be, for example, social ties exercised using connections provided and/or utilized by network-based services over a network. Three examples of such network-based services include e-mail, instant messaging and Yahoo! 360° (a service that facilitates creating a centralized repository of information to share with other users by invitation), but there are numerous other possible network-based services. Social ties may be inferred by other means as well, not related to being exercised using connections provided by service providers via the network 112. As just one example, a telephone directory database may be processed and, based thereon, it may be determined that two people having the same last name live at the same address. It can be inferred from this information, with some degree of certainty, that these two people have a social tie (family).

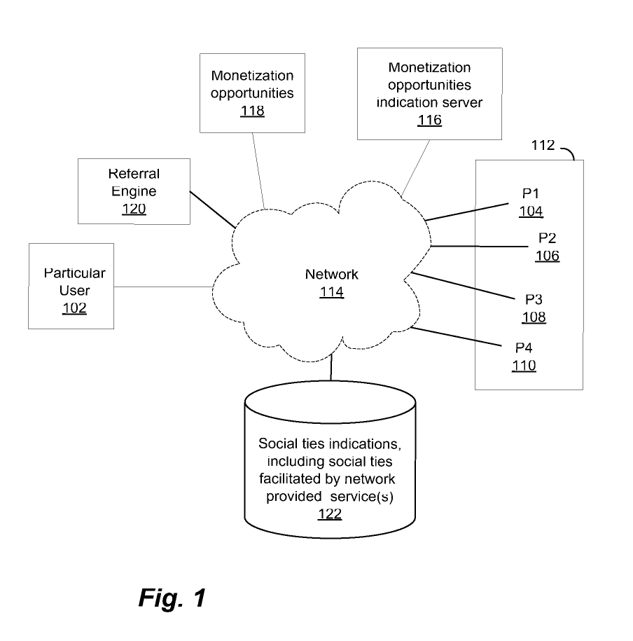

FIG. 1 is a block diagram illustrating an example architecture of a system in which a monetization opportunity that is determined to have been presented to or additionally monetized by a particular user (e.g., an advertisement on which the particular user clicked or another advertisement) may be referred, via the computer network, to at least one other user of the network-based services, other than the particular user, with whom the particular user has social ties.

Referring to FIG. 1, a particular user 102 is connected to a network 114 such as the internet. A plurality of other users 112 (including user P1 104, user P2 106, user P3 108 and user P4 110 and, typically, many other users) are also connected to the network 114. The users exercise social ties to each other using connections provided by service providers via the network 114. The network 114 is not limited to being the internet but, rather, should be interpreted expansively to include various networks that connect device users. Social ties may be inferred by other means as well, not related to use of connections provided by service providers via the network 114.

Monetization opportunities 118 are referred to the particular user 102 based on monetization opportunity indications provided from a monetization opportunities indication server 116. Thus, for example, as a result of a user providing a query to a search engine, the monetization opportunities indication server may provide indications of advertisements (e.g., URL's) to be displayed in conjunction with the search results. The monetization opportunities may be, for example, advertisements provided by advertisers who have bid to have their advertisements displayed in conjunction with search results for one or more particular search terms. Such bidding may carried out using, for example, a bid tool provided as part of the Yahoo!® Search Marketing tool suite. Other monetization opportunities may include offers to purchase a subscription, a product or a service.

Based at least in part on a determination that the particular user 102 has been presented or additionally monetized a monetization opportunity (e.g., that the particular user 102 has been displayed an advertisement or additionally that the particular user 102 has clicked on an advertisement displayed to him, such as in conjunction with search results or has completed a purchase via the monetization opportunity), the referral engine 120 causes a monetization opportunity (which may be, but need not be, the same monetization opportunity monetized by the particular user 102) to be referred to one or more of the other users 112 with which the particular user 102 has social ties (as indicated, for example, by the social ties indications 122). The referral engine 120 may include, for example, one or more computing devices operating in a programmed manner according to a program tangibly embodied on a computer readable medium.

We now discuss more details of referrals, including some specific examples of how referrals to other user may be accomplished. In one example, the referred monetization opportunity may be directly provided to the other users, as a generally independent operation. As just one example of this type of referral, an e-mail including the referred monetization opportunity may be caused to be sent to the other users, and may include an indication that the referral came from the particular user.

As another example, the referral may be provided to the other users as part of an operation in which monetization opportunities generally are provided to the other users anyway. For example, information of the referral may be provided to an advertisement targeting model relative to the other users, and the information of the referral may then be used by the advertisement targeting model when advertisements are provided to the other users (e.g., as a result of one of the other users providing a search term to a search engine, such that advertisements generally are displayed in conjunction with the search results).

As one example, the targeting model may be configured to give absolute weight to the referral information, such that the referred advertisement is always displayed to one of the other users when advertisements would have been displayed to that user anyway. As another example, the targeting model may be configured to give less than absolute weight to the referral information, such that the referral information is considered as a user characteristic, potentially along with other user characteristics (such as demographic or geography associated with the other user), potentially along with other factors that are not user characteristics, in determining whether to actually provide the referred advertisement to the other user. Advertisement targeting models that consider user characteristics and other factors are known in the art and, therefore, details of such are not described here.

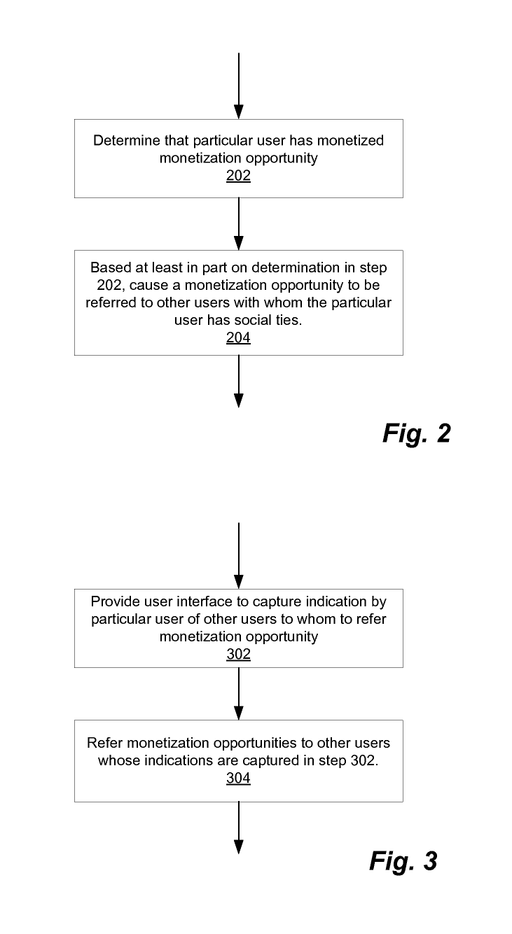

FIG. 2 is a flowchart illustrating an example of processing (e.g., within the referral engine 120 of the FIG. 1 system) to achieve a referral of a monetization opportunity. At step 202, it is determined that a particular user has been presented or additionally has monetized a monetization opportunity. At step 204, based at least in part on the determination in step 202, a monetization opportunity is caused to be referred to other users with whom the particular user has social ties (e.g., as discussed above with reference to FIG. 1, based on social ties indications 122).

We now discuss how it may be determined who are the other users to whom a monetization opportunity may be referred. In one example, in conjunction with a particular user (such as the particular user 102 in FIG. 1) being presented or additionally monetizing a monetization opportunity, a user interface is provided to the particular user to capture an indication of the other users whom to refer a monetization opportunity. For example, the user interface may provide a list of indications of other users that a referral engine (such as the referral engine 120 in FIG. 1) may have determined are appropriate for referral of a monetization opportunity from the particular user. The user interface may have a mechanism for the particular user to confirm (or not confirm) the determination of the referral engine, or to confirm only some of the other users for referral of a monetization opportunity, or to add users that are not included in the other users determined by the referral engine, or some combination of any or all of these.

FIG. 3 is a flowchart illustrating an example of processing with respect to a user interface such as that just discussed. At step 302, a user interface is provided to capture an indication by the particular user of other users whom to refer a monetization opportunity. The other users are users with whom the particular user has a social tie, for example, as discussed above. At step 304, monetization opportunities are referred to the other users, the indications of which are captured at step 302.

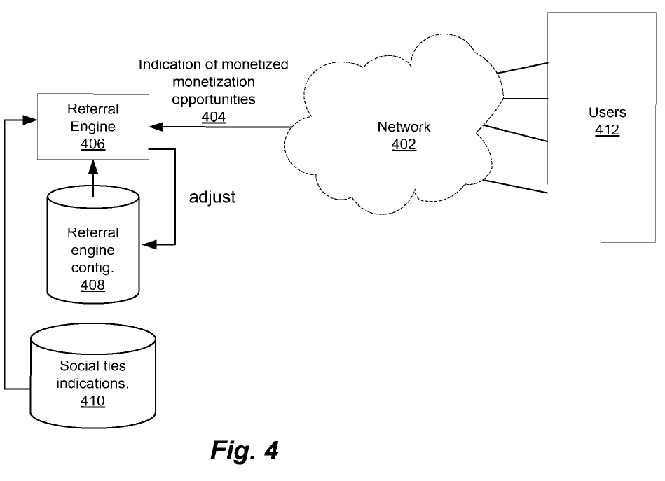

In accordance with an example, illustrated in the block diagram of FIG. 4, a determination of the other users and/or referral weights associated with targeting of the other users may be made by a referral engine 406 (which may be, for example, the referral engine 120 in FIG. 1) based at least in part on a referral engine configuration 408 and social ties indications 410. As also illustrated in FIG. 4, the referral engine configuration 408 may be adjusted, such as by the referral engine 406 as shown in FIG. 4 to adjust the other users to whom a monetization opportunity is referred and/or referral weights associated with the targeting of the other users.

For example, the referral engine configuration 408 may be adjusted based on information feedback of actual monetized monetization opportunities. In one example, the lift (increased response rate) generated by social tie-based referrals is measured. For example, the response rate of the same advertisement when referred and not referred may be compared. If there is a positive lift, then weights associated with targeting other users based on social ties may, in general, be increased for that advertisement. If there is no lift, or if the change is negative, then weights associated with targeting other users based on social ties may, in general, be reduced for that advertisement.

The lift generated by referrals may be considered at some granularity, such as according to a characteristic of the social ties between the particular user and particular other user(s) who monetize the referred advertisements. In this way, the targeting weights may be adjusted for only some of the other users to whom an advertisement is referred (for example, for those users having one or more similar characteristics determined to contribute to a change in lift), and not necessarily for all of the other users to whom the advertisement is referred.

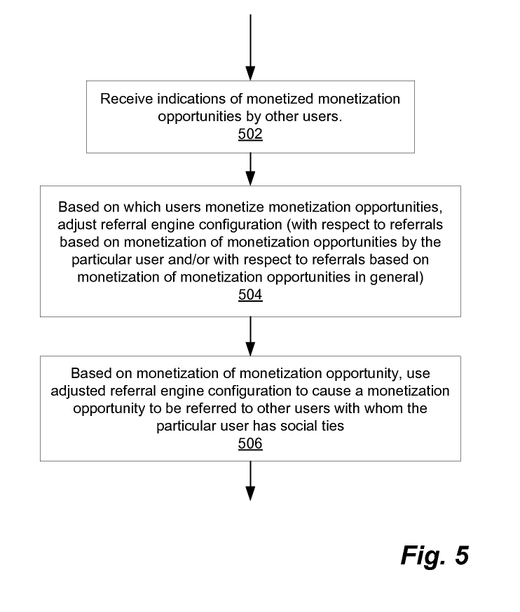

FIG. 5 is a flowchart illustrating processing that may occur with respect to the FIG. 4 system. At step 502, an indication is received of monetized monetization opportunities by other user. At step 504, based on which users monetize the monetization opportunities, the referral engine configuration is adjusted, with respect to referrals based on monetization of monetization opportunities by the particular user and/or with respect to referrals based on monetization of monetization opportunities in general. At step 506, based on monetization of the monetization opportunity, the adjusted referral engine configuration is used to cause a monetization opportunity to be referred to other users with whom the particular user has social ties.

We have described methods whereby, by using social tie information to refer monetization opportunities (such as advertisements) to other users, monetization of the monetization opportunities (such as clickthrough rates of advertisements) may be enhanced.

What is claimed is:

1. A computer-implemented monetization opportunity referral method, comprising:
determining that a particular user of network-based services has been presented a monetization opportunity offered to the particular user via a computer network;
based at least in part on the determination, causing a monetization opportunity to be referred, via the computer network, to at least one other user of the network-based services, other than the particular user, with whom the particular user has social ties.

2. The method of claim 1, wherein:
the determining step further comprises determining that the particular user has additionally monetized the monetization opportunity.

3. The method of claim 1, wherein:
the particular user has the social ties to the at least one other user of the network-based services via connections provided by the network-based services.

4. The method of claim 1, wherein:
the particular user has the social ties to the at least one other user of the network-based services other than via connections provided by the network-based services.

5. The method of claim 1, wherein:
causing the monetization opportunity to be referred to the at least one other user includes causing the monetization opportunity to be referred without requiring an indication of action from the particular user other than an indication of action to monetize the monetization opportunity.

6. The method of claim 1, wherein:
the monetization opportunity offered to the particular user is one of the group consisting of an advertisement, an offer to purchase a subscription and an offer to purchase a product or service.

7. The method of claim 1, wherein:
the monetization opportunity referred to the at least one other user is one of the group consisting of an advertisement, an offer to purchase a subscription and an offer to purchase a product or service.

8. The method of claim 1, wherein:
the step of determining whether the particular user has monetized a monetization opportunity includes determining whether there is an indication the particular user has performed an action with respect to the monetization opportunity that results in money being made.

9. The method of claim 1, wherein:
causing the monetization opportunity to be referred to the at least one other user includes causing the referred monetization opportunity to be presented to the at least one other user in a normal course of presenting monetization opportunities to the at least one other user.

10. The method of claim 1, wherein:
causing the monetization opportunity to be referred to the at least one other user includes causing the referred monetization opportunity to be directly delivered to the at least one other user, other than in a normal course of presenting monetization opportunities to the at least one other user.

11. The method of claim 1, wherein:
causing the monetization opportunity to be referred to the at least one other user includes providing an indication of the referral to a monetization opportunity targeting model.

12. The method of claim 11, further comprising:
operating the monetization opportunity targeting model to consider the provided referral indication as one of a plurality of characteristics of the at least one other user to whom the referral is provided.

13. The method of claim 11, further comprising:
causing adjustment of a weight corresponding to the indication of the referral provided to the monetization opportunity targeting model.

14. The method of claim 11, further comprising:
receiving indications based on one or more of the at least one other user monetizing the referred monetization opportunity and, based thereon, causing adjustment of a weight corresponding to the indication of the referral provided to the monetization opportunity targeting model.

15. The method of claim 14, wherein:
causing adjustment of the weight includes determining the adjustment based on a lift corresponding to the referred monetization opportunity.

16. The method of claim 11, wherein:
causing adjustment of the weight includes increasing the weight as a function of positive lift corresponding to the referred monetization opportunity.

17. The method of claim 14, wherein:
causing adjustment of the weight includes decreasing the weight as a function of the zero or negative lift corresponding to the referred monetization opportunity.

18. The method of claim 1, further comprising:
receiving at least one indication that at least one of the at least one other user has monetized the monetization opportunity; and
based at least in part thereon, adjusting which users are included in the plurality of other users, with respect to referring subsequent monetization opportunities.

19. The method of claim 18, wherein:
the adjusting step is further based on characteristics of the social ties between the particular user and the at least one other user.

20. The method of claim 18, wherein:
the adjusting step is further based on characteristics of the social ties between the particular user and the at least one other user in view of the social ties between the user and the indicated at least one of the at least one other user.

21. The method of claim 1, wherein:
causing the monetization opportunity to be referred to the at least one other user includes causing the monetization opportunity to be referred based at least in part on an indication of additional action from the particular user in addition to an indication of action by the particular user to monetize the monetization opportunity.

22. The method of claim 21, wherein:
the indication of additional action from the particular user includes an indication of the at least one other user.

23. The method of claim 22, further comprising:
causing a user interface to be presented to the particular user, indicating a plurality of other users with whom the particular user has social ties;
wherein the indication of the at least one other user is received via the presented user interface.

24. A method of targeting a user of a network-based service with at least one monetization opportunity, comprising:
processing characteristics of the user relative to a targeting model, wherein a characteristic being processed includes an indication of a monetization opportunity referred to the user by a referring user;
based at least in part on the processing, determining the at least one monetization opportunity.

25. The method of claim 24, wherein:
the determined at least one monetization opportunity includes the referred monetization opportunity.

26. The method of claim 24, wherein:
the indication of the referred monetization opportunity includes an associated weight.

27. The method of claim 26, further comprising:
adjusting the associated weight based on monetization of the referred monetization opportunity by other users to whom the referring user has referred the monetization opportunity.

28. A method of maintaining a user information collection system usable by a targeting model to determine whether to target a particular user who has been referred a particular monetization opportunity by a particular referring user with whom the particular user has a social tie, comprising:
maintaining a targeting weight for the referral associated with the user and the particular monetization opportunity; and
adjusting the targeting weight for the referral to the particular user based at least in part on an amount of lift achieved as a result of referral of the particular monetization opportunity to users other than to the particular user.

29. The method of claim 28, wherein:
the adjusting step is additionally based on the lift achieved as a result of referral of the particular monetization opportunity to users other than to the particular user, as a function of characteristics of the social ties between the referring user and the users other than to the particular user, relative to a characteristic of the social tie between the referring user and the particular user.

30. A system configured to refer monetization opportunities, comprising at least one computing device configured to:
determine that a particular user of network-based services has been presented a monetization opportunity offered to the particular user via a computer network;
based at least in part on the determination, cause a monetization opportunity to be referred, via the computer network, to at least one other user of the network-based services, other than the particular user, with whom the particular user has social ties.

31. The system of claim 30, wherein:
the at least one computing device is further configured to determine additionally that the particular user has monetized the monetization opportunity offered to the particular user.
